(19) United States
(12) Patent Application Publication
(10) Pub. No.: US 2005/0204191 A1
(43) Pub. Date: Sep. 15, 2005

(54) Systems and methods automatically classifying electronic data

(76) Inventors: Jay McNally, Rehoboth, MA (US); Peter Tierney, Greenville, RI (US); Roman Asadovsky, N. Attleboro, MA (US); Aliaksei Dzienis, N. Providence, RI (US)

Correspondence Address: ROBERT J. DEPKE;LEWIS T. STEADMAN, TREXLER, BUSHNELL, GLANGLORGI, BLACKSTONE & MARR, 105 WEST ADAMS STREET, SUITE 3600, CHICAGO, IL, 60603-6299, US

(21) Appl. No.: 10/797,547

(22) Filed: Mar. 10, 2004

(51) Int. Cl. G06F 11/00

(52) U.S. Cl. 714/15

(57) ABSTRACT

The present invention relates generally to the field of recovering stored electronic data and, more specifically, the systems and methods disclosed in the instant application are directed to automatically analyzing stored electronic information in order to identify file differences and provide file categorization information.

### BACKGROUND OF THE INVENTION

1. Field of the Invention

The present invention relates generally to the field of recovering stored electronic data and, more specifically, the systems and methods disclosed in the instant application are directed to determining modification and deletion of stored electronic data and for automatically analyzing modifications and deletions to provide categorization information.

2. Description of the Related Art

The dramatic growth in rapid and convenient electronic communication such as, for example, electronic mail, has also seen a corresponding growth in the need for recovering and analyzing this data particularly during litigated disputes and regulatory enforcement activities, for example in support of the Securities and Exchange Commission Regulations implementing the Sarbanes Oxley Act, the Securities Act of 1934 (as Amended) and the Health Insurance Portability and Accountability Act.

Recently, the dramatic increase in electronic communications including electronic mail and business documents has also seen a tremendous growth in the storage of this data, in large part as a result of retention obligations of public companies in compliance with said regulations. During litigation or regulatory actions it is necessary to recover and analyze this stored information for the purpose of accurately, with certainty sufficient to serve as evidence under Federal guidelines, determining the occurrence of certain events. This problem is particularly difficult in light of the fact that electronic mail and document storage systems, particularly in large organizations, are used hundreds of times every day by even a single individual. Tremendous amounts of information are stored, transferred, generated and replicated.

For organization with thousands of individuals, simple requests for production of this information alone during litigated disputes can be overwhelming. Furthermore, the analysis of this data can also be virtually impossible without electronic assistance. This is true for even such basic determinations as whether the information contained within the system is responsive to a particular request for production. In large organizations, it is not uncommon to maintain systems that store literally billions of data files. Additional complexity is added by requests for recovering data that have been archived or which may have existed as of an earlier point in time during use of the system.

The electronic systems used for the storage of other electronic data, including correspondence files, memos, spreadsheets and other data, contain information that can be used to determine the behavior of users of electronic data. In the simplest cases, the information embedded in electronic mail data, for example, typically (for example in compliance with standard for electronic messages including RFC822) indicates the sender, the recipients, the time sent, and other data regarding the electronic mail message, whether or not this data is evident to the user. Such embedded data that, rather than being the content of the message, describes the details of the message creation and transmission, is called metadata. Similar data about the creation and modification of electronic data relating to office documents such as word processing files, spreadsheet files, database files and other application files exists.

Metadata is typically valuable, and is used, in support of litigants' claims. Recovering all instances of messages and analyzing them and their associated metadata has proven valuable in the prosecution and defense of legal claims. Valuable metadata may also be associated with other non-electronic mail files including documents, correspondence memos and spreadsheets.

Known techniques for the analysis of electronic data and metadata rely on the presence of the data in current systems or in a backup format that is available in or recoverable into current systems. These techniques are limited by the availability of certain types of data and metadata. If the required metadata and data are not available or have been modified at all, the known methods fail. It is common during the normal use of electronic files that metadata is modified. For example if a file is opened, the metadata that represents the last date modified will be changed, whether or not the contents of the file are modified. It is not possible with known methods to distinguish between modifications of files that are material changes in evidence and modifications that are not.

Yet another shortcoming and deficiency of existing conventional systems is that during automated analysis of two sets of stored electronic data files, the existing systems are only able to determine that a difference exists. For example, currently there are systems available that perform bit level difference analysis by reviewing the MD5 hash value, for example, for every file. While these existing techniques can determine whether a difference exists, the end result is that they ultimately are unable to conclude if interesting user behavior created the difference. Currently there are no systems available that provide any useful information or categorization concerning these differences that would be useful in asserting the reason why the difference exists, or categorizing a variety of reasons that may have caused the difference. The existing systems are only able to identify stored files wherein a difference exists. Unfortunately, these existing systems ultimately cause unnecessary efforts and analyzing files that have been modified in an insignificant manner.

Accordingly, there remains a need in the art for new and improved systems and methods for recovering and analyzing electronic data. Additionally, there remains a need in the art for new and improved systems and techniques for analyzing differences in stored file information beyond simple bit level differences that may fall out of check-sum comparisons. Other objects and advantages of the present invention will be apparent in light of the following Summary and Detailed Description of the Presently Preferred Embodiments.

### SUMMARY OF THE INVENTION

The present invention is directed to systems and methods for identifying modification and deletion of stored electronic data in order to evidence user behavior regarding the electronic data. Furthermore, the systems and methods of the present invention improve the ability for the automated analysis of the stored information in order to identify and establish categories such as, for example, missing files which are either truly missing as a result of deletion or moved and modified files. Furthermore, the systems and methods of the present invention are able to identify modified files such as, for example, those that have the same path but are different according to a calculated parameter, for example an MD5 hash value and/or metadata. It will be apparent to those skilled in the art that the uniqueness can be calculated in a various ways, for example, by filtering the file utilizing Fourier or wavelet transforms.

In accordance with another aspect of the present invention, the systems and methods described herein provide the ability to analyze stored electronic files and provide information beyond mere differences in the data. For example, the systems and methods described herein are able to establish categories of missing files, which are either truly missing files as a result of intentional deletion, and/or moved and modified files. Furthermore, the system is able to determine and identify modified files that have the same path but different MD5 hash and metadata values.

This information is determined through analyzing two sets of server restores on the files so that comparisons of MD5 and metadata may be made. Comparisons are made to determine whether the same file name, size and short path name are present. Differences are then analyzed. Based on this analysis it is possible to determine whether the file is modified in place, moved or deleted, for example.

In accordance with this aspect of the present invention, data statistics are collected relating to every file on each server including the original date of creation information and last modified date, file size, file name, file path as well as the MD5 hash value. Files that have been modified in place and which have the same data path on each server but have different contents are identified. Files that have the same path, the same last modified date, and the same size can therefore be eliminated from consideration.

A further operational element of the analysis identifies partial differences in the two data sets that result from elimination of files with the same MD5 hash value. This is accomplished by analyzing the frequency of equivalent MD5 hash values. When multiple files are identified, subsequent short path analysis is performed to determine which occurrence was eliminated. This information can be particularly interesting and relevant to litigation when a particular user who is identified by the short path analysis deleted a particular file of interest. The analysis allows for a deterministic categorization of differences in files on two server images.

### BRIEF DESCRIPTION OF THE DRAWINGS

FIG. 1 illustrates a first exemplary preferred embodiment of the present invention; and

FIG. 2 illustrates an alternate exemplary preferred embodiment of the present invention;

FIG. 3 illustrates an alternate exemplary preferred embodiment of the present invention.

### DETAILED DESCRIPTION OF THE PRESENTLY PREFERRED EMBODIMENTS

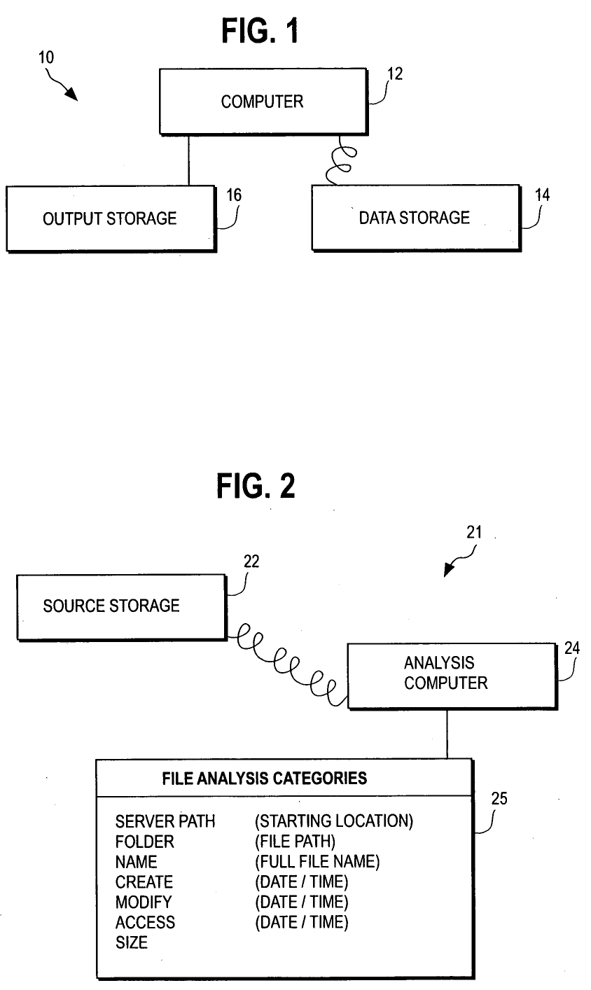

FIG. 1 illustrates a first preferred exemplary of the present invention which is shown generally at 10. In accordance with the first preferred exemplary embodiment, a computer system operating a data recovery program such as the computer 12 is connected to an electronic data file storage archive 14. The electronic data file storage archive 14 is used to store and maintain a plurality of electronic data files. Electronic data files are typically stored business documents such as spreadsheets and word processing documents for example. Those skilled in the art will appreciate that files are one class of electronic data and that the present invention could compare any class of electronic data objects. During the recovery process, the computer 12 which is connected to the electronic data file storage archive 14 may be connected either directly or via a network connection such as, for example, through a conventional local area network or LAN, or even the Internet. Those skilled in the art will appreciate that a hard wired LAN or wireless connectivity may be utilized as well. In the alternative, the recovery program may be run on a computer having associated storage containing the data to be recovered such as a PC with a hard drive within which the data is stored.

The electronic data file storage archive 14 may be embodied as one or more and preferably a plurality of a typical conventional hard drives, electronic magnetic tape drives, CDs or DVDs, for example. Those skilled in the art will appreciate that the particular hardware utilized for storage of the data is not important and that virtually every data storage including RAM or double EEPROM flash memories may be utilized as well. Those skilled in the art will also appreciate that the embodiment of the electronic data is not important and that virtual or real time data streams could be utilized as input and output as well. Subsequently developed data storage hardware will also be compatible. Similarly, the mechanism for connecting the computer running the program which is used during the recovery process is not important. All that is necessary is access and the ability to transfer files. It should also be recognized that the data recovery computer need not be physically near the data storage 14 within which the data to be recovered is located. For example, in a system that utilizes the Internet for connectivity, the computer utilized for recovery may actually be many hundreds of miles away from the actual data to be recovered.

In the preferred exemplary embodiment, a plurality of computers such as the computer 12 operate in parallel on files that are stored in data storage 14.

The original file storage such as one or more backup tapes for a system may be transferred to data storage 14 or a further storage mechanism 16 for the purpose of speeding up the analysis process. The further storage mechanism 16 may be embodied as a typical conventional hard drive, electronic magnetic tape drive, CD or DVD, for example.

In accordance with one aspect of the present invention, the systems and methods described herein provide the ability to automatically analyze stored electronic files and provide information beyond mere differences in the data. In accordance with the preferred exemplary embodiment, a single computer running a single computer program may be utilized for performing this aspect of analyzing the recovered data. Those skilled in the art will appreciate that it is not necessary for a single machine to perform both tasks and that is actually preferable that the tasks are split up such that two or more different machines individually perform these tasks and it is most preferred that multiple machines may be used in parallel for performing these tasks on substantial data storage mechanisms.

The systems and methods described herein are able to establish categories of missing files, which are either truly missing files as a result of intentional deletion, and/or moved and modified files. Furthermore, the system is able to determine and identify modified files that have the same path but different MD5 hash and metadata values.

In accordance with this aspect of the present invention, data statistics are collected relating to every file on each server in which the desired data is stored including the original date of creation information and last modified date, file size, file name, file path as well as the MD5 hash value as a representation of the uniqueness of the file. Those skilled in the art will appreciate that the uniqueness of the file could alternatively be expressed in terms of Fourier or wavelet transforms of the file. Those skilled in the art will also appreciate that the stored data may be the original data or a copy of the original data that has been recovered in accordance with the aspects of operation noted above.

Files that have been modified in place and which have the same data path on each server but have different contents are identified. Files that have the same path, the same last modified date, and the same size can therefore be eliminated from consideration. By eliminating these files from consideration, significant duplication of effort is eliminated which was a substantial problem with systems and methods utilized in the prior art.

A first aspect of the analysis identifies partial differences in the two data sets that result from elimination of files with the same MD5 hash value. This is accomplished by analyzing the frequency of equivalent MD5 hash values. When multiple files are identified, subsequent short path analysis is performed to determine which occurrence was eliminated. This information can be particularly interesting and relevant to litigation when a particular user who is identified by the short path analysis deleted a particular file of interest. The analysis allows for a deterministic categorization of differences in files on two server images. This operational aspect of the system may be utilized to establish categories of
1. Missing files, either
   a. Truly missing, as a result of, for example, deletion OR
   b. Moved and Modified
2. Modified files, those that have the same path, but different MD5 hash and metadata
   This analysis allows for deterministic categorization of differences in files on two server images as either Missing, Modified or Partially Deleted. There is currently no commercially available means to perform this categorization.

This same analysis can also be used to determine whether files from one file server are also on another file server, for example if there is a suspicion that files from one firm were transferred to another. The resulting information is then delivered in two forms: lists of files that fall into each category and TIFF images of these files along with a standard load file for a document management system, making the review and production of this information straight forward. The analysis is structured in a manner that makes this comparison of even very large data sets quite manageable. The data output may be provided on the data storage mechanism 16 as noted above.

In the performance of this analysis, the term “source” refers generically to a file system. In the exemplary embodiment described with reference to FIG. 2, the “source” is a file server snapshot consisting of a wide array of electronic documents, from user-created “office” documents, to software application files, etc which are stored on a server or other computer or networked storage such as data store 22. In addition to file servers, individual hard drive backups could be considered a source. An analysis computer 24 that is provided with access to the data store 22 is preferably connected to the data store 22 via a network connection. The network connection can be effected through either a hard-wired connection, fiber optic network or even a wireless connection. Those skilled in the art will appreciate that the connection referenced in FIG. 2 can also be made through the internet.

The analysis described with reference to FIG. 2 is most often used to compare two backup sessions from the same file server at different points in time, to determine, if files were deleted or otherwise manipulated and how the data sets have changed. In the prior art, comparisons were typically between two sets of data would typically be performed on databases where the structure of the data lends itself to query-based comparisons. Those skilled in the art will also appreciate that the source storage 22 is not limited to a single data storage device and that data from two distinct electronic storage mechanisms may be compared for the purpose of the analysis described herein.

Prior to the instant innovation, file system comparisons in electronic discovery would typically consist of an MD5 hash comparison to identify missing or modified files (and not distinguish between them). For example, the systems of the prior art could identify all of the MD5 hash values which appear in Set A but not in Set B. However, this process would not go to the level where missing files are distinguished from modified files and “partially deleted” files are identified. The automated analysis was thus significantly hampered.

The inventive analysis of the preferred exemplary embodiment examines each source independently and collects information related to file contents and characteristics of the file. Once the source is restored, metadata is gathered for each file within the data set. For example, FIG. 2 illustrates an exemplary list of fields of metadata captured for each file at 25 including:
server path (starting location of the data)
folder (file path)
name (full file name)
create (date/time)
modify (date/time)
access (date/time)
size
md5 hash value
   This data is acquired using a dedicated custom utility which examines any subfolders to gather file statistics and which also incorporates a commercially available MD5 hash generator. These file statistics are then used to determine which files occur in one set and not the other, which files occur in both sets and which files exist in both sets but were modified. One novel aspect of this analysis is that the system is able to identify “interesting differences,” not simply bit level differences that would fall out of a check-sum comparison, for example the MD5 hash value for every file. Those skilled in the art should appreciate that the list of file characteristics set forth in FIG. 2 is not exhaustive and that other file characteristics may be examined as well.

By generating this information, files that have been “modified in place,” that is, have the same path on each server but have different contents are identified.

A file is considered “modified” if, during the time period between the two snapshots being compared, a change was made to the file resulting in a change to the MD5 hash value. A modification could consist of any number of actions. For example, the file could be opened and the contents truly modified (i.e., edited) by the user. Or, the modification could consist of an automatic update to an auto function within the document (e.g., an update to field which contains “today's date”). Additionally, simply opening certain files can change information within the file, such as “date last opened” or “last opened by”, thus changing the MD5 hash value—even if the document is not saved by the user and the change itself is transparent to the user.

The process of identifying the “modified in place” files begins with the identification of files in the “older” set whose MD5 values do not exist in the newer data set. A second comparison takes place to see if the file itself is truly missing from the data set, by comparing the files paths and filenames between the two sets. If a file has a different MD5 hash value, but still appears in the same place on the file server with the same name, this file is considered “modified in place”—it has been modified in some manner as evidenced by the change in the MD5 hash, but it still exists in the same place with the same name when we compare file paths and file names. (Files which have an MD5 hash which no longer appears in the data set, and no longer exists in the same location with the same name, form the “missing” or “moved and modified” set).

As previously mentioned, a file can be modified by an action as simple as opening the file. This type of alteration may be considered insignificant to the investigation at hand. This subset can be identified by further examining the file metadata. These types of modifications, despite changing the MD5 hash value, typically do not alter the last modification date or the file size of the file. Therefore, by identifying those records within the “modified in place” set that have the same last modification dates and file sizes between the two snapshots, these files can be removed from the analysis.

An additional element of the analysis indicates partial differences in the two datasets that result from elimination of files with the same MD5 hash value. This is accomplished by analyzing the frequency of equivalent MD5 hash values.

If multiple copies of the same document exist on a file server, it is possible for one or more copies of the file to be deleted or removed from the file system while still leaving at least one copy of the document present. This activity, which may be useful to the investigation, would not be identified by looking at MD5 hash values which exist in the earlier set and not in the newer set, since at least one occurrence of the unique MD5 value would exist in both sets.

In order to identify these “partial deletions”, a frequency analysis is performed on the pool of MD5 hash values which occur in both data sets, with the purpose of identifying those MD5 values which have a greater frequency in the older data set when compared to the newer data set. File information is pulled for each MD5 which meets the criteria. For example, a unique MD5 value may occur two times in the earlier set and only once in the newer set. The full file information would be pulled for each occurrence of the file:

For example, consider the following example.

Early Set:

Projects\ProjectX\Documents\Document1.txt
Projects\ProjectABC\Documents\Document1.txt
   Newer Set:
Projects\ProjectX\Documents\Document1.txt
   By further performing a “short path analysis”, the precise occurrence of the file which is missing in the newer set can be determined. In this example, the file in the path “Project ABC” is no longer present in the newer data set. This file would be considered a “partial delete”.

When multiples are identified, subsequent short path analysis is performed to determine which occurrence was eliminated. It can be interesting and relevant to litigation or other investigations that a particular user (identified by the short path analysis) deleted a particular file. Generally, when source backup tapes are restored to a target server, high level folders indicating the backup set or other information such as backup date, etc. are created for organizational purposes. Additionally, the two sets of data will likely be restored to two different locations in the target environment. These resultant, high level folders which occur on the target server need to be considered when comparing the paths and file names between two sets of data. Consider the following two file paths:
\\Target1\Set1\Source1\Projects\ProjectX\Documents\Document1.txt
\\Target2\Set1\Source2\Projects\ProjectX\Documents\Document1.txt
   For comparison purposes, the relevant path as it existed on the client's server begins with the folder “Projects”. If a comparison is performed beginning with this folder, the comparison will show that the file path and file names are the same between these two files. If the entire string were compared, the high level folders would negate the accuracy of the comparison.

A “short path analysis” is the process whereby this non-relevant path information is “trimmed” in the database so that true path comparisons can be performed.

This analysis allows for deterministic categorization of differences in files on two server images as, for example, Missing, Modified or Partially Deleted. Other possible categorizations include a schema of the genesis of a specific copy of a file, or an expression of the growth of a folder tree in which the file is stored.

As previously mentioned, typical conventional comparisons in the industry would focus solely on the MD5 hash comparison portion of the process in order to identify the MD5 values which were present in one set but not in another, leading to a general “missing or modified” categorization. The additional automated analysis of the present invention provides significant advantages over the systems of the prior art.

A further categorization that the system is capable of providing distinguishes between the “substantially” modified files and those which have a different MD5 value, but no change in the file size or the last modification date—“substantive” vs. “non-substantive” modifications.

This same analysis can also be used to determine whether files from one file server are also on another file server, for example if there is a suspicion that files from one firm were transferred to another. Since file level information is gathered for each source, including the unique MD5 value for each file present, a comparison could be performed between any two file system sources to identify common files. Therefore, as opposed to performing an analysis on the same source data in two different points in time for the purpose of identifying the differences, a comparison is performed on two unrelated sources to identify common files between the two. In the example mentioned, if it was suspected that confidential or proprietary documents were transferred from one company to the other, all files sharing common characteristics could be identified when comparing the servers from each company.

The resulting information is then delivered in two forms: lists of files that fall into each category and TIFF images of these files along with a standard load file for a document management system, making the review and production of this information straightforward. The analysis is structured in a manner that makes this comparison of even very large data sets quite manageable.

Those skilled in the art will appreciate that the data output could also be provided in a variety of different formats, for example, copies of the files, HTML renderings, lists, pointers, et cetera and that it is not necessary to employ all of the same specific analysis and output described with reference to the preferred exemplary embodiment. For example, the output information can be placed on a CDROM or DVD or other file storage device. In the alternative, a computer program can be used to present the file analysis information and selectively present the relevant documents and/or document statistics to a user.

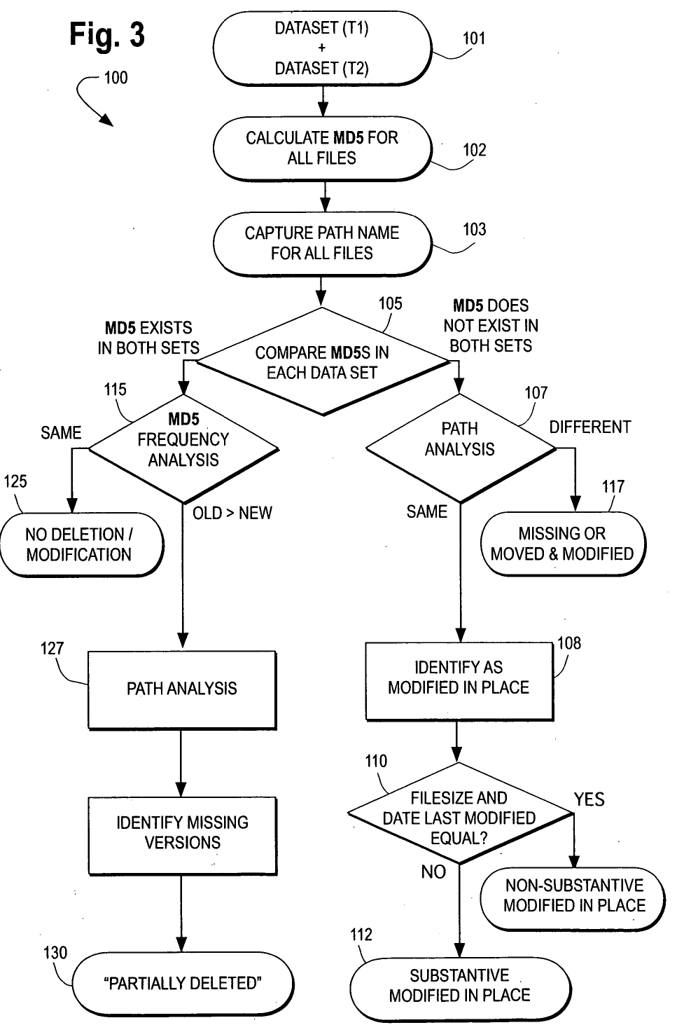

FIG. 3 is a flow diagram which illustrates the general processing of the data comparison analysis for the purpose of automatically generating file categorizations which designate categories of activities that have taken place with respect to files that have been altered from a first time period to a second time period. This is generally shown in the flow diagram at 100. As shown at FIG. 3, in a first step 101, data sets 1 and 2 are initially acquired. Thereafter, the system performs a calculation of the MD5 hash values for all files in each of the data sets. This occurs in step 102. In step 103 the path names for each of the files in the various data sets are captured. The particular sequence of events described in steps 102 and 103 is not particularly important. All that is necessary is ultimately this information is available for the purpose of subsequent analysis.

In step 105 a comparison is made for the MD5 hash values that have been determined for each of the files. Depending upon whether the MD5 has values exist in both sets or does not exist, different types of analysis is applied as shown in the two alternate paths from step 105. If the MD5 hash value does not exist in both data sets, a subsequent path analysis is performed. This takes place in step 107 as shown. In step 107, if the same path exists, the file is identified as being modified in place as shown in step 108. Thereafter, in step 110, it is determined whether the file size and date last modified are the same. If these are determined to be the same then the file is classified as having a non-substantive modification and a designation that the file has been modified in place. Alternatively, if the files are not equal as shown in step 112, the file receives the designation as having received substantive modifications in the same file storage location.

Step 115 indicates an alternate path from step 105 wherein the file having a MD5 have value does not exist in both data sets and has a different path analysis that is classified as being a missing or moved and modified file as shown in step 117. As shown in the alternate path from step 105, the MD5 frequency analysis is performed if the MD5 hash value for a file exists in both data sets. If the frequency for the file is the same, then it is determined that no deletion or modification of the file has been made. This is shown in step 125. In the alternative, if the frequency for the old data set is greater than the frequency for the new data set, then subsequent path analysis is performed as shown in step 127. It is through this path analysis that it is possible to identify missing versions of the file. Thereafter, these files are designated as being partially deleted as shown in step 130. This designation is an indication that although the file exists in each of the data sets, one or more copies of the file have been deleted and therefore the file is designated as partially deleted as shown therein. It is through this advantageous automated classification system that significant volumes of electronic data can be processed in order to quickly automatically classify tremendous amounts of data in a very short period of time. This was previously not possible.

The systems and methods have been described herein with reference to the presently preferred exemplary embodiments of the present invention. Those skilled in the art will appreciate that the inventions described herein are not limited to the specific implementations described specifically above but that substitution and alteration of these systems will nevertheless fall within the spirit and scope of the claims set forth below.

1. A system for recovering electronic documents archived in a data storage mechanism comprising:
a computer connected with said data storage mechanism, where the computer retrieves a stored data file comprising original electronic document data information and further wherein the retrieved stored data file is automatically analyzed and categorized into one or more of a plurality of distinct categories.

2. The system of claim 1, wherein the computer is connected via a network connection to the data storage mechanism.

3. The system of claim 1, wherein the computer is connected via a wireless network connection to the data storage mechanism.

4. The system of claim 1, wherein the further data storage mechanism is a hard drive.

5. The system of claim 1, wherein the further data storage mechanism is a tape drive.

6. The system of claim 1, wherein the further data storage mechanism is a DVD.

7. The system of claim 1, wherein the further data storage mechanism is a CD-ROM.

8. A method for recovering electronic mail archived in a data storage mechanism comprising the steps of:
providing a computer with access to said data storage mechanism;
retrieving a stored data file comprising original electronic mail data information from the data storage mechanism; and further wherein the retrieved stored data file is automatically analyzed and categorized into one or more of a plurality of distinct categories.

9. The method of claim 8, wherein the computer is connected via a network connection to the data storage mechanism.

10. The method of claim 8, wherein the computer is connected via a wireless network connection to the data storage mechanism.

11. The method of claim 8, wherein the further data storage mechanism is a hard drive.

12. The method of claim 8, wherein the further data storage mechanism is a tape drive.

13. The method of claim 8, wherein the further data storage mechanism is a DVD.

14. The method of claim 8, wherein the further data storage mechanism is a CD-ROM.
